(19) United States
(12) Patent Application Publication
(10) Pub. No.: US 2026/0370714 A1
(43) Pub. Date: Nov. 19, 2026

(54) SYSTEMS AND METHODS FOR ENSURING PROBABILISTIC LATENCY-RELIABILITY FOR CLOUD ROBOTICS

(71) Applicant: Robert Bosch GmbH, Stuttgart (DE)

(72) Inventors: Kaiyuan CHEN, Berkeley, CA (US); Christian JUETTE, Santa Clara, CA (US); Nan TIAN, Foster City, CA (US); Tianshuang QIU, Berkeley, CA (US); Marcus GUALTIERI, Fremont, CA (US); Michael WANG, Mountain View, CA (US)

(21) Appl. No.: 19/210,250

(22) Filed: May 16, 2025

(51) Int. Cl. H04L 67/12; G05D 1/226; H04L 67/101; H04L 67/1034

(52) U.S. Cl. CPC H04L 67/12; G05D 1/226; H04L 67/101; H04L 67/1034

(57) ABSTRACT

Methods for communicating, via proxy compute nodes, communications-framework-based communications (e.g., Robot Operating System (ROS2) communications) between an autonomous robot or vehicle and a remote cloud server are disclosed. The reliable offloading framework orchestrates the transmission and reception of packets of data via multiple network interfaces, thus reducing latency of communications between the autonomous robot or vehicle and the cloud server and also improving reliability of those types of communications. Pairings between respective network interfaces, both on the side of the cloud server and on the side of the autonomous robot or vehicle, are optimized to minimize the probability of missing a deadline. By providing replicated servers with uncorrelated failures, the probability of missing a deadline is also significantly reduced.

### TECHNICAL FIELD

The present disclosure relates to orchestrating reliable and low-latency communications between cloud-connected autonomous robots or vehicles.

### BACKGROUND

In the past, cloud-connected services in mobility and robotics have typically suffered from unreliability due to network congestions, network failures, or server failures. To make offloading computation viable for more demanding applications, latency-reliability of the cloud services also needs to be scaled accordingly. As used herein, improving latency-reliability may be defined as reducing the mean end-to-end latency for communication with a cloud service, thus reducing the maximum end-to-end latency, as well as reducing jitter of this latency over time.

Past implementations that do not optimize for latency-reliability typically refers to connectivity stacks in robots or cars that use a single internet connection to a single endpoint in the cloud. This endpoint may be a single server but may also be a load balancer with a single Uniform Resource Locator (URL) that distributes requests to other servers in the background. However, this results in multiple Single Points Of Failure (SPOFs), including instances in which the whole system fails and experiences high latency when either the communication link fails or is congested, or when the endpoint or server fails, or is over-utilized to a point in which failure is inevitable.

### SUMMARY

In an embodiment, a method for establishing connectivity between a proxy compute node and a cloud server is provided. The method includes: generating connectivity threads for corresponding network interfaces within an autonomous vehicle that are configured to send and receive packets of data to a cloud server, wherein the cloud server orchestrates computer-vision operations of the autonomous vehicle; generating Linux-based sockets for the network interfaces; executing a cloud-deployed Session Traversal Utilities for Network Address Translators (STUN) protocol to output cloud-accessible network Internet Protocol (IP) addresses for respective ones of the network interfaces; establishing connectivity between the respective ones of the network interfaces and corresponding compute nodes of the cloud server based on the cloud-accessible network IP addresses; and sending and receiving, via a proxy compute node located within the autonomous vehicle, communications-framework-based communications for performance of computer-vision related operations of the autonomous vehicle based on the established connectivity.

In another embodiment, a method for communicating, via a proxy compute node, communications-framework-based communications is provided. The method includes: receiving, from a communications-framework-specific application located within a sensor of an autonomous vehicle and to a proxy compute node located within the autonomous vehicle, a request to send packets of data to a cloud server, wherein the cloud server orchestrates computer-vision related operations of the autonomous vehicle; mapping two or more network interfaces to corresponding compute nodes of the cloud server, based on optimizing combinations of network interface and compute node pairings, wherein the two or more network interfaces are to be used to send the packets of data; replicating and subsequently transmitting the packets of data via the two or more network interfaces; receiving, via a given one of the two or more network interfaces, a communications-framework-based communication to the proxy compute node; and providing the communications-framework-based communication to an actuator of the autonomous vehicle for performance of a given computer-vision related operation of the autonomous vehicle.

In another embodiment, a system including a processor and memory containing instructions that, when executed by the processor, cause the processor to perform these steps.

In another embodiment, a non-transitory computer-readable medium includes instructions that, when executed by a processor, cause the processor to perform these steps.

### BRIEF DESCRIPTION OF THE DRAWINGS

FIG. 1 illustrates a high-level overview of a software framework that enables reliable and low-latency communications between cloud-connected mobile robots or vehicles when offloading latency-sensitive, stateless tasks, according to some embodiments.

FIG. 2 illustrates workflows for establishing connectivity between an autonomous robot or vehicle and one or more compute nodes of a cloud server and for communicating, via a proxy compute node, communications-framework-based communications (e.g., Robot Operating System (ROS) based communications) between those components, according to some embodiments.

FIG. 3A is a flow diagram that illustrates a process of establishing connectivity between an autonomous vehicle and one or more compute nodes of a cloud server, according to some embodiments.

FIG. 3B is a flow diagram that illustrates a process of communicating, via a proxy compute node, communications-framework-based communications between an autonomous vehicle and one or more compute nodes of a cloud server, according to some embodiments.

FIG. 4A is a geographical map that illustrates an example driving route taken by an autonomous vehicle within a first case study implementation shown in FIGS. 4A-4F of orchestrating ROS2-based communications between an autonomous vehicle and one or more compute nodes of a cloud server using systems and methods described herein, according to some embodiments.

FIG. 4B illustrates a moment in time along the driving route shown in FIG. 4A in which a handover causes a service interruption due to lack of use of systems and methods described herein.

FIG. 4C illustrates the same moment in time along the driving route shown in FIG. 4A in which the handover does not cause a service interruption, due to the use of systems and methods described herein, according to some embodiments.

FIG. 4D illustrates a number of service interruptions along the driving route shown in FIG. 4A when a single service provider (e.g., Verizon) is used and the systems and methods described herein are not applied to handovers that occur along the driving route.

FIG. 4E illustrates another number of service interruptions along the driving route shown in FIG. 4A when another single service provider (e.g., AT&T) is used and the systems and methods described herein are not applied to handovers that occur along the driving route.

FIG. 4F illustrates a decrease in service interruptions along the driving route shown in FIG. 4A due to using the systems and methods described herein during application of handovers that occur along the driving route, according to some embodiments.

FIG. 5A illustrates a second case study implementation, shown in FIGS. 5A-5E, of the systems and methods described herein in which two compute nodes of a cloud server orchestrate computer-vision related tasks of an autonomous robot, according to some embodiments.

FIG. 5B illustrates a comparison between using systems and methods described herein (namely a reliable offloading framework in the figure) and not using the systems and methods described herein (namely Wi-Fi and 5G in the figure), according to some embodiments.

FIG. 5C illustrates an amount of latency and frequency of latency that is accrued when the systems and methods described herein are not applied during the second case study implementation introduced in FIG. 5A, and instead simply Wi-Fi connectivity is used.

FIG. 5D illustrates another amount of latency and frequency of latency that is accrued when the systems and methods described herein are not applied during the second case study implementation introduced in FIG. 5A, and instead simply 5G connectivity is used.

FIG. 5E illustrates the significantly less latency and frequency of latency that is accrued when the systems and methods described herein are applied during the second case study implementation introduced in FIG. 5A, according to some embodiments.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

As introduced above, when implementing cloud robotics services for autonomous robots and vehicles, past implementations fall victim to multiple Single Points Of Failure (SPOFs) that inevitably inflicts high latency between the autonomous robot or vehicle and the cloud-based computational services and instructions that are supposed to be sent and received in real-time or near real-time.

Those past implementations attempted to address this problem in various ways. For example, some methods would handle server failures and some levels of network congestion by provisioning multiple redundant servers and switching between them after recognized failures. However, these attempted solutions failed to address the “first hop” of the network connection (e.g. a Wi-Fi or 5G network interface link), but instead assumed that this link is and would remain reliable and also provide sufficient network characteristics, such as bandwidth and latency. In another example, other methods simply handle server failures by replication in the web, but do not properly treat network connectivity.

Other past implementations, such as Apple's Wi-Fi Assist, attempted to address the first hop of the network connection by switching between network interfaces in the case of a degrading network connection. However, such implementations simply react to network failures, and also take a long time to switch between network interfaces (e.g., a time within a range of seconds). Switching in this way often also triggers a new connection establishment. In the case that one network interface vanishes, applications either do not react at all and stop functioning, or they need to restart and/or reload some aspect of themselves (e.g. restart a stream, reestablish a connection to a server etc.).

In yet other past implementations, such as Multipath Transmission Control Protocol (TCP), multiple local network interfaces were used to transmit a single input data stream to a single server slightly more reliably by creating multiple TCP connections over multiple paths and then spreading traffic across those so-called sub flows. In Multipath TCP, the focus is on communicating with a single server, leaving SPOFs to occur in the system itself. Multipath TCP also does not perform packet replication by default, and rather a single packet travels just on a single sub flow. This is also severely limiting, as the actions to counteract latency are simply reactive instead of proactive.

In contrast, the systems and methods described herein pertain to a probabilistic latency-reliable cloud robotics platform, operating on unreliable commodity infrastructure. Even when using an unreliable commodity infrastructure, defined herein as cheap, latency unreliable and error-prone compute, network, and storage infrastructure, the probabilistic latency-reliable cloud robotics platform significantly reduces latency between autonomous vehicles or robots and their cloud-based server(s). Furthermore, by providing replicated resources with uncorrelated failures, failure probability is reduced exponentially.

For ease of discussion herein, the systems and methods described herein that pertain to a probabilistic latency-reliable cloud robotics platform is also referred to as a reliable offloading framework. The reliable offloading framework may be defined as a cloud robotics framework that uses multiple independent networks for communications-framework-based communications (ROS2-based communications) between autonomous robots, or autonomous vehicles, and failure-independent compute resources in a cloud server to achieve probabilistic latency reliability on commodity cloud infrastructure. It should be understood that the use of any communication frameworks for cloud robotics, such as ROS2, Message Queuing Telemetry Transport (MQTT), or Open Platform Communications Unified Architecture (OPC-UA), are meant to be included in the description herein. The reliable offloading framework is agnostic to a type of communications framework.

Moreover, the reliable offloading framework is configured to discover, connect, and simultaneously routes messages through multiple non-default network interfaces on autonomous robots or vehicles to identical services deployed in up to multiple cloud data centers, and then uses the first response received from the replicated services as instructions to that autonomous robot or vehicle within a context of stateless computer-vision related operations. The reliable offloading framework thus significantly increases the probability of getting timely responses to and from those essential cloud robotics components, as long as at least one replica and the network remain operational and responsive. The reliable offloading framework optimizes the selection of network interfaces to cloud-deployed robotics algorithms by minimizing the probability of deadline misses.

The following description continues with an introduction to the reliable offloading framework, which is defined as the cloud robotics framework that applies independent network interfaces and cloud services for latency reliability within a context of cloud robotics applications. Then, implementations of the reliable offloading framework during (1) establishment of connectivity and (2) orchestration of communications-framework-based communications between an autonomous robot or vehicle and a cloud server are described. In addition, an algorithm that may be executed to determine an optimal choice of network interface and compute node pairing is discussed. The present disclosure then demonstrates the versatility of the systems and methods described herein for incorporation into various technologies and larger systems, such as for human tracking by an autonomous robot and for autonomous driving implementations.

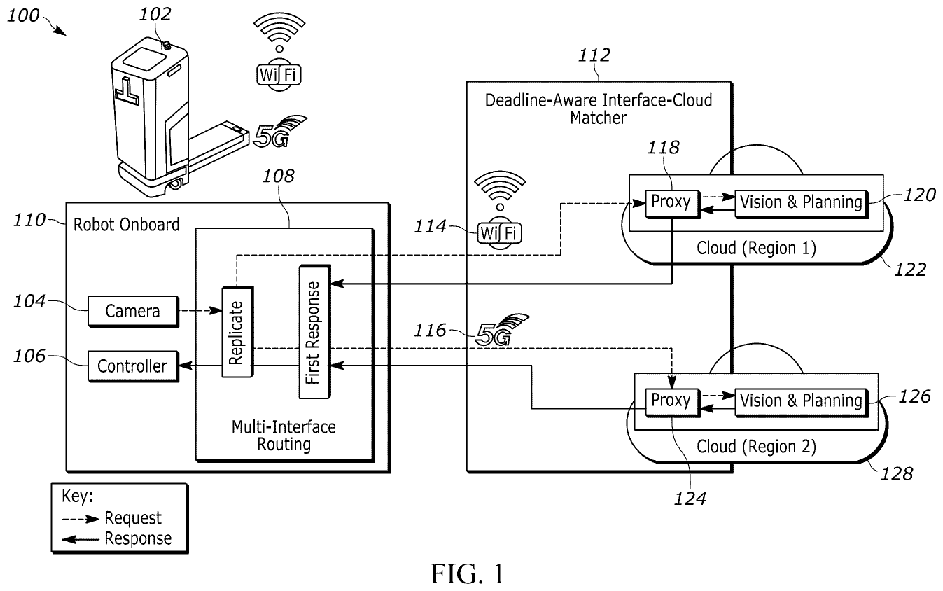

FIG. 1 illustrates a high-level overview of a software framework that enables reliable and low-latency communications between cloud-connected mobile robots or vehicles when offloading latency-sensitive, stateless tasks, according to some embodiments.

As shown in FIG. 1, mobile autonomous robots and autonomous vehicles, such as autonomous robot 102, may connect to cloud services for various applications. In cloud robotics environment 100, autonomous robot 102 is configured to connect to cloud 122 and to cloud 128 via multi-interface routing 108.

By applying a paradigm and a software framework to achieve probabilistically latency-reliable distributed services in unreliable public networks using commodity hardware, the reliable offloading framework enables computationally intensive algorithms to be offloaded from autonomous robot 102 to the cloud 122 and 128 while also providing quality of service standards in terms of latency and availability. The reliable offloading framework utilizes redundancy and replication in multiple levels to achieve fault tolerance and latency-reliability, and thus eliminating SPOFs.

As shown in cloud robotics environment 100, the reliable offloading framework is configured to transparently proxy communications-framework-based communications, such as ROS2-based communications. The program instructions are configured to send communications-framework-based communications via multiple network interfaces, such as Wi-Fi network interface 114 and 5G network interface 116 to replicated Cloud Virtual Machines (VMs), such as cloud 122 and cloud 128. The reliable offloading framework proxies 118 and 124 then provide those communications to the respective compute nodes 120 and 126 of the cloud server, which are responsible for orchestrating stateless computer-vision related operations of the autonomous robot 102.

For example, camera 104 may resemble a sensor located within autonomous robot 102 that is configured to provide image-based data samples to cloud 122 and cloud 128 via the reliable offloading framework. More specifically, image-based data samples from camera 104, or some other sensor of autonomous robot 102, may be sent from a communications-framework-specific application to a proxy compute node located within autonomous robot 102. The information may also include a request to send packets of data, or the image-based data samples in this case, to the cloud server that is responsible for orchestrating stateless computer-vision related tasks and operations of autonomous robot 102.

Proxy compute nodes located within autonomous robot 102 then replicate and subsequently transmit the packets of data across at least two network interfaces, such as Wi-Fi network interface 114 and 5G network interface 116. Proxy compute nodes 118 and 124 then receive and relay the packets of data to compute nodes 120 and 126 of cloud 122 and 128. Similarly, compute nodes 120 and 126 may then prepare and request to transmit a communications-framework-based communication to autonomous robot 102, such as program instructions for an actuator, e.g., controller 106, of autonomous robot 102, based on the packets of data received from camera 104. Proxy compute nodes 118 and 124 then replicate and transmit those program instructions across at least two network interfaces, such as Wi-Fi network interface 114 and 5G network interface 116, to multi-interface routing 108, such that the program instructions can be routed to controller 106. This process may continue for the duration of the utility of autonomous robot 102.

Moreover, a first response that is received to multi-interface routing 108 is the set of program instructions that is provided to controller 106. For example, if the program instructions are first received via Wi-Fi network interface 114, the program instructions are then provided to controller 106 without waiting for the duplicate instructions to arrive from 5G network interface 116. Latency-reliability of the communications framework is thus ensured.

The reliable offloading framework acts as a proxy that enables unmodified communications-framework-based applications to seamlessly integrate with the communications framework illustrated by cloud robotics environment 100. By replicating requests, packets of data, and program instructions over multiple independent network interfaces to cloud servers at different regions and subsequently routing the first response back, latency-reliability is achieved. Furthermore, by selecting different combinations of network interface and compute node pairings, a number of potential correlated failures are reduced.

In the example above, image-based data samples from camera 104 are used as an example of the types of packets of data that may be replicated and transmitted using the methods described herein. However, various other sensors located within autonomous robot 102 are also meant to be encompassed by “packets of data,” such as audio-based data samples, video-based data samples, or text-based data samples.

Also illustrated in cloud robotics environment 100 is latency-aware and deadline-aware interface-cloud matcher 112. The reliable offloading framework is also configured to map two or more network interfaces to corresponding compute nodes of the cloud server based on optimizing combinations of network interface and compute node pairings. This mapping minimizes the probability of deadline miss. These mappings will be used when sending packets of data.

To determine which network interface of an available plurality of network interfaces should be used to connect to which compute node of a given cloud server and/or to different cloud servers, the reliable offloading framework is configured to minimize the probability of missing the latency deadline by applying deadline-aware interface-cloud matcher 112. The deadline-aware interface-cloud matcher 112 algorithm may be described by the following.

Suppose the system consists of n possible cloud servers

$${\{ {s}_{j} \}}_{j = 1}^{n} ,$$

and on the autonomous robot, there are m network interfaces that are able to connect to those cloud servers. A binary decision variable xᵢⱼ is used to denote if network interface i should be used to connect with cloud server sⱼ, wherein

$${x}_{ij} = \{ \begin{matrix}1 , & if interface i is connected to server {s}_{j} \\ 0 , & otherwise\end{matrix} ,$$

and the latency Lᵢⱼ is a probability of missing the deadline when using network interface i to connect with cloud server sⱼ.

The objective function can therefore be written as:

$$Minimize {\sum }_{i = 1}^{m} {\sum }_{j = 1}^{n} {L}_{ij} \cdot {x}_{ij} ,$$

which is subject to the following constraints.

Firstly, binary decision variables are defined as: xᵢⱼ∈{0,1}∀i∈{1, 2, . . . , m}, ∀j∈{1, 2, . . . , n}. Secondly, respective autonomous robot, or vehicle, network interfaces should connect to a respective cloud server:

$${\sum }_{j = 1}^{n} {x}_{ij} = 1 ∀ i ∈ \{ 1 , 2 , ... , m \} .$$

Thirdly, capacity of a number of connections to respective cloud servers is defined by:

$${\sum }_{i = 1}^{m} {x}_{ij} \leq 1 ∀ j ∈ \{ 1 , 2 , ... , n \} .$$

This optimization problem can be solved using integer programming to find the optimal assignment of autonomous robot, or vehicle, network interfaces to cloud servers that minimize latency while satisfying the constraints. Moreover, Lᵢⱼ can be measured by separately estimating the compute and network time, with the computational time. This reduces the overhead of profiling. For example, if the system uses one class of cloud servers for computation, the network data is collected by permuting the network interfaces to the cloud servers.

As additionally illustrated in FIG. 1, Robot Onboard 110 includes various components of an autonomous robot, such as 102. As the description herein pertains to the use of both autonomous robots and autonomous vehicles within a context of cloud robotics, it should be understood that a similar figure with a camera 104 sensor located within an autonomous vehicle could similarly operate using the reliable offloading framework.

As such, the following description of interactions between a computer-controlled machine and a control system may be applied to the systems and methods described herein.

A computer-controlled machine may include one or more actuators and one or more sensors. Such sensors are configured to sense a condition of the computer-controlled machine. For example, a given sensor may be configured to sense ID and/or OOD data, and the corresponding processors can be configured to determine whether the data is ID or OOD according to the teachings herein. The given sensor may be configured to encode the sensed condition into sensor signals and to transmit sensor signals to control system. Non-limiting examples of such sensors include a camera, video sensor, radar, LiDAR, ultrasonic and motion sensors, temperature sensors, and the like. In one embodiment, the sensor is an optical sensor configured to sense optical images of an environment proximate to the computer-controlled machine.

The corresponding control system is configured to receive sensor signals from the computer-controlled machine. As set forth below, the control system may be further configured to compute actuator control commands depending on the sensor signals and to transmit actuator control commands to an actuator of the computer-controlled machine.

The control system may include a receiving unit. The receiving unit may be configured to receive sensor signals from a sensor and to transform the sensor signals into input signals x. In an alternative embodiment, sensor signals are received directly as input signals x without a receiving unit. Each input signal x may be a portion of each sensor signal. The receiving unit may be configured to process each sensor signal to product each input signal x. Input signal x may include data corresponding to an image recorded by a given sensor.

The control system includes computationally intensive robotics algorithms and machine learning models. For example, the control system may be configured to classify input signals x into one or more labels using a machine learning algorithm, such as via object detection models and classifiers. The computationally intensive robotics algorithms and machine learning models are configured to be parametrized by parameters (e.g., parameter θ). Parameters θ may be stored in and provided by non-volatile storage. The computationally intensive robotics algorithms and machine learning models are configured to determine output signals y from input signals x. Each output signal y includes information that assigns one or more labels to each input signal x. The computationally intensive robotics algorithms and machine learning models may transmit output signals y to a conversion unit. The conversion unit is configured to convert output signals y into actuator control commands. The control system is configured to transmit actuator control commands to an actuator, which is configured to actuate the computer-controlled machine in response to actuator control commands. In another embodiment, the actuator is configured to actuate the computer-controlled machine based directly on output signals y.

Upon receipt of actuator control commands by the actuator, the actuator is configured to execute an action corresponding to the related actuator control command. The actuator may include a control logic configured to transform actuator control commands into a second actuator control command, which is utilized to control the actuator. In one or more embodiments, actuator control commands may be utilized to control a display instead of or in addition to an actuator.

The control system also includes a processor and memory. The processor may include one or more processors. Memory may include one or more memory devices.

Non-volatile storage of the control system may include one or more persistent data storage devices such as a hard drive, optical drive, tape drive, non-volatile solid-state device, cloud storage or any other device capable of persistently storing information. The processor may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory. Memory may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

The processor may be configured to read into memory and execute computer-executable instructions residing in non-volatile storage and embodying one or more machine-learning algorithms. Non-volatile storage may include one or more operating systems and applications. Non-volatile storage may store compiled and/or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

Returning to examples in which cloud robotics environment 100 encompasses a control system that is configured to control a vehicle which is at least partially autonomous, the following description may also be applied to the systems and methods described herein.

In such embodiments, an autonomous vehicle 102 includes actuator 106 and sensor 104. Sensor 104 may include one or more video sensors, cameras, radar sensors, ultrasonic sensors, LiDAR sensors, and/or position sensors (e.g. GPS). One or more of the one or more specific sensors may be integrated into autonomous vehicle 102. In the context of sign-recognition and processing, for example, the sensor 104 is a camera mounted to or integrated into the autonomous vehicle 102. Alternatively or in addition to one or more specific sensors identified above, sensor 104 may include a software module configured to, upon execution, determine a state of actuator 106. One non-limiting example of a software module includes a weather information software module configured to determine a present or future state of the weather proximate to autonomous vehicle 102 or other location.

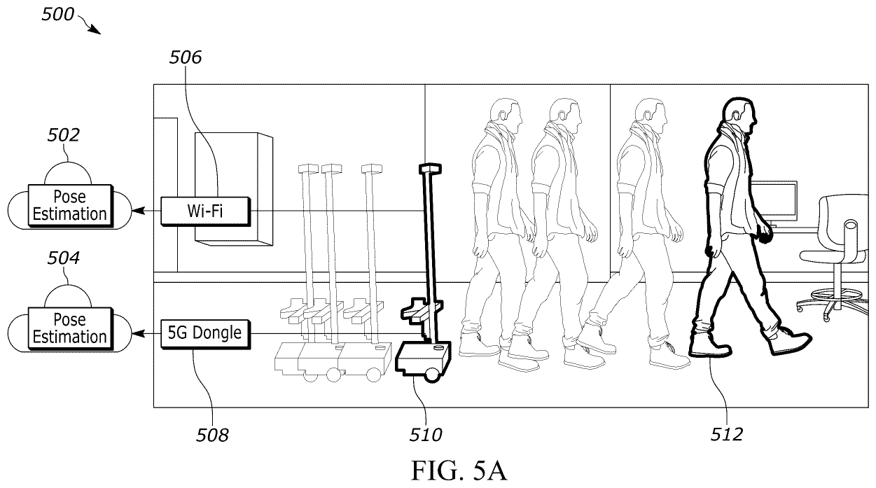

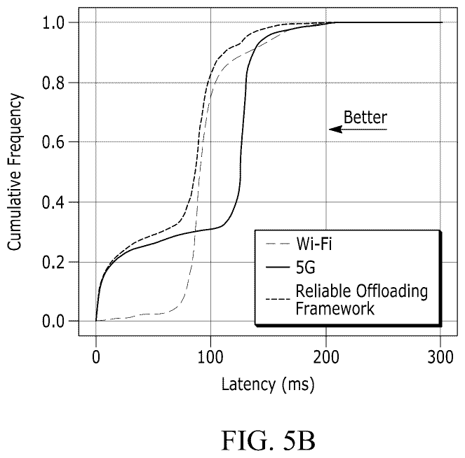

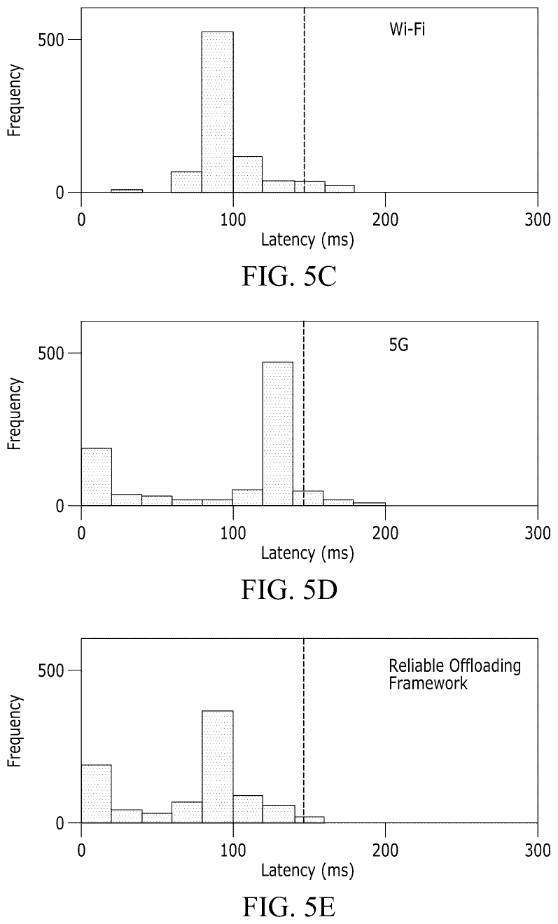

Computer vision and planning 120 and 126 of a remote control system of autonomous robot or vehicle 102 may be configured to detect objects in the vicinity of autonomous vehicle 102 dependent on input signals x. In such an embodiment, output signal y may include information characterizing the vicinity of objects to autonomous vehicle 102. An actuator control command may be determined in accordance with this information. The actuator control command may be used to avoid collisions with the detected objects. See also FIGS. 5A-5E herein.

In embodiments where autonomous vehicle 102 is an at least partially autonomous vehicle, actuator 106 may be embodied in a brake, a propulsion system, an engine, a drivetrain, or a steering of autonomous vehicle 102. Actuator control commands may be determined such that actuator 106 is controlled such that autonomous vehicle 102 avoids collisions with detected objects. In a scenario where an adversarial attack may occur, the system described above may be further trained to better detect objects or identify a change in lighting conditions or an angle for a sensor or camera on autonomous vehicle 102.

In other embodiments where autonomous robot 102 is an at least partially autonomous robot, autonomous robot 102 may be a mobile robot that is configured to carry out one or more functions, such as flying, swimming, diving and stepping. The mobile robot may be an at least partially autonomous lawn mower or an at least partially autonomous cleaning robot. In such embodiments, the actuator control commands may be determined such that a propulsion unit, steering unit and/or brake unit of the mobile robot may be controlled such that the mobile robot may avoid collisions with identified objects.

In another embodiment, autonomous robot 102 is an at least partially autonomous robot in the form of a gardening robot. In such embodiment, autonomous robot 102 may use an optical sensor, such as sensor 104, to determine a state of plants in an environment proximate autonomous robot 102. Actuator 106 may be a nozzle configured to spray chemicals. Depending on an identified species and/or an identified state of the plants, actuator control commands may be determined to cause actuator 106 to spray the plants with a suitable quantity of suitable chemicals.

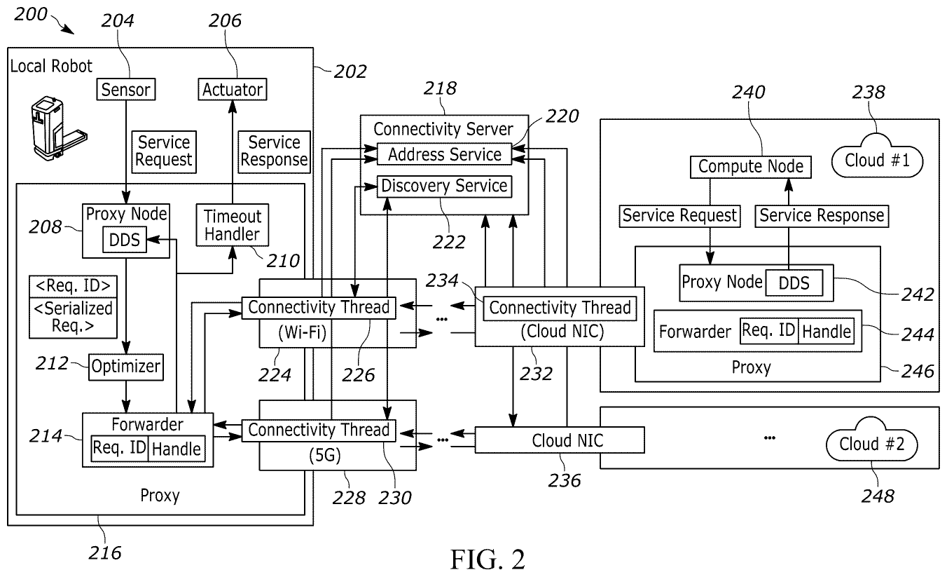

FIG. 2 illustrates workflows for establishing connectivity between an autonomous robot or vehicle and one or more compute nodes of a cloud server and for communicating, via a proxy compute node, communications-framework-based communications (e.g., ROS2-based communications) between those components, according to some embodiments.

In some embodiments, cloud robotics environment 200 illustrates the deployment of the reliable offloading framework for handling requests with fault tolerance. The following paragraphs firstly detail a workflow in which the reliable offloading framework establishes connectivity between at least one proxy compute node and at least one compute node of a cloud server. Then, the next paragraphs detail another workflow in which the reliable offloading framework orchestrates communications-framework-based communications via a proxy compute node between at least one proxy compute node and at least one compute node of a cloud server. For ease of discussion in the following paragraphs, ROS2-based communications are discussed. However, it should be understood that MQTT or OPC-UA based communications could similarly be applied to the below description, since the reliable offloading framework is agnostic to the type of communications framework being used.

Moreover, the particular embodiments in cloud robotics environment 200 continue with an example of an autonomous robot 202 that receives program instructions from cloud server 238 and cloud server 248. However, it should be understood that, in other embodiments, an autonomous vehicle may be configured in a similar way to receive program instructions from cloud server 238 and cloud server 248, and that the particular embodiments in cloud robotics environment 200 are not meant to be restrictive in nature as to the deployment configurations of the reliable offloading framework.

Furthermore, description for sensors and actuators of autonomous robot 102, which is provided above, is also meant to be applicable to sensor 204 and actuator 206 of autonomous robot 202.

During a connection setup phase, the reliable offloading framework is configured to generate connectivity threads for respective network interfaces that are located within autonomous robot 202. These network interfaces are configured to enable the sending and receiving of packets of data between autonomous robot 202 and cloud servers 238 and 248. The generation of connectivity threads may also include the generation of Linux-based sockets for the network interfaces that forces the network interface to bind to the socket, even if the particular network interface is not a default network interface.

In addition, the network interfaces that are selected to be part of the connectivity establishment process are failure-independent network interfaces. For example, an interruption of Wi-Fi network interface 224 is independent of the functionality of 5G network interface 228, and vice versa. Moreover, the stability of Wi-Fi network interface 224 does not directly influence stability of Cloud NIC 232, and so on.

As shown in FIG. 2, connectivity thread 226 is generated for Wi-Fi network interface 224, and connectivity thread 230 is generated for 5G network interface 228. In order to reduce latency, the reliable offloading framework is configured to generate connectivity threads for at least two network interfaces, such that replicated packets of data may then be transmitted. So far, the reliable offloading framework has been discussed from a perspective of autonomous robot 202. However, and as shown in FIG. 2, additional connectivity threads are also generated from the perspective of cloud servers 238 and 248, wherein connectivity thread 234 is generated for Cloud Network Interface Card (NIC) 232, and another connectivity thread is generated for Cloud NIC 236, and so on.

Next, a cloud-deployed Session Traversal Utilities for Network Address Translators (STUN) protocol is executed on connectivity server 218 in order to output cloud-accessible network Internet Protocol (IP) addresses for respective ones of the network interfaces described in the previous paragraphs. By executing the STUN protocol, cloud-connectable network addresses from non-default network interfaces is ensured, whether the network interfaces are local or virtual, such as in cases of Virtual Private Networks that are private to autonomous robot 202.

A given period of time may pass during execution of the STUN protocol. Responsive to a failure to output a cloud-accessible network IP address for a given one of the network interfaces shown in FIG. 2 after that period of time, the corresponding connectivity thread is disconnected. That particular network interface will not be used or attempted to be used in future transmissions of packets of data until the connectivity is reestablished.

For other network interfaces for which the cloud-accessible network IP addresses are obtained, connectivity is then established between autonomous robot 202 and the respective cloud server.

As also shown in FIG. 2, the establishment of connectivity, and thus connectivity threads between autonomous robot 202 and cloud servers 238 and 248, may be orchestrated via a connectivity server 218. In some embodiments, connectivity server 218 may be located proximate to autonomous robot 202. Moreover, addressing and discovery actions are labeled herein as address service 220 and discovery service 222 for ease of discussion. Once a connectivity thread advertises itself to discovery service 222 using its cloud-accessible network IP address, discovery service 222 is configured to run another protocol in order to exchange addresses of discovered addresses. Furthermore, both address service 220 and discovery address 222 may correspond with autonomous robot 202 and cloud servers 238 and 248 via public Internet or in private network settings. As connectivity server 218 is used for establishing connectivity, no packets of data later pass through connectivity server 218, thus ensuring that no server failure is initiated due to use of connectivity server 218.

The following paragraphs now detail a workflow in which the reliable offloading framework orchestrates ROS2-based communications via a proxy compute node between at least one proxy compute node and at least one compute node of a cloud server.

This workflow occurs at a moment in time after which point connectivity has been established between Wi-Fi network interface 224 and Cloud NIC 232 via connectivity threads 226 and 234 and between 5G network interface 228 and Cloud NIC 236 via connectivity thread 230 and another connectivity thread. Moreover, autonomous robot 202 is now ready to provide packets of data from sensor 204 to cloud servers 238 and 248, and is ready to receive program instructions to actuator 206 regarding stateless computer-vision related operations.

As introduced above, sensor 204 is configured to provide, via an ROS2 application, a request to send packets of data to the cloud server, in which the packets of data include image-based data samples, audio-based data samples, video-based data samples, or text-based data samples, depending upon the type of sensor. The request to send the packets of data is received by a proxy compute node, such as proxy node 208 of proxy 216.

Next, the request is extracted as a serialized request with a unique identifier. In some embodiments, the unique identifier is extracted from the ROS2 middleware layer (e.g., ‘rmw’). Proxy node 208 is then configured to cause the unique identifier and the request to send the packets of data to be stored.

Subsequently, a mapping of two or more network interfaces to corresponding compute nodes of at least one cloud server is performed in preparation for connectivity threads by which to send the packets of data of the request. As introduced above with regard to deadline-aware interface-cloud matcher 112, network interface and compute node pairings are optimized for by proxy 216. For ease of discussion herein, a pairing between Wi-Fi network interface 224 and Cloud NIC 232 is made, and another pairing between 5G network interface 228 and Cloud NIC 236 is made. In order to ensure latency-reliability, at least two pairings are used to send and receive packets of data between autonomous robot 202 and cloud servers 238 and 248.

Then, optimizer 212 and forwarder 214 of proxy 216 cause the packets of data to be replicated and subsequently transmitted via Wi-Fi network interface 224 to Cloud NIC 232, and via 5G network interface 228 to Cloud NIC 236. In some embodiments, forwarder 214 is also configured to register the unique identifier and request with a callback for response and a callback for timeout, in the event that no program instructions are later received in a timely manner from either cloud server 238 or cloud server 248.

On the side of cloud servers 238 and 248, the packets of data are received to proxy 246, which then provides the packets of data to the respective compute nodes, such as to compute node 240 of cloud server 238, via forwarder 244 and proxy node 242. Compute node 240 then executes a computationally intensive algorithm or machine learning model for computer-vision related tasks of autonomous robot 202 and using the received packets of data. Once compute node 240 outputs program instructions in the format of ROS2-based communication for autonomous robot 202, proxy 246 is then configured to similarly replicate and transmit the program instructions via Cloud NICs 232 and 236.

When a given one of the ROS2-based communications is received by proxy 216, such as via Wi-Fi 224 or 5G network interface 228, proxy 216 is configured to verify that the ROS2-based communication includes the same unique identifier that matches the original unique identifier of the original request. Once verified, proxy 216 provides the ROS2-based communication to actuator 206 for performance of the computer-vision related operation of autonomous robot 202.

When a first response is received, such as via Wi-Fi 224, and if the unique identifier indeed matches, proxy 216 marks the given request as complete. Upon receiving a second, third, or later response via another one of the network interfaces, such as via 5G network interface 228, those redundant, or duplicate, responses are discarded, since the request is already marked as complete.

Moreover, when a first response is received, proxy 216 is additionally configured to verify that a passage or period of time is less than the originally set callback for timeout. Timeout handler 210 monitors for this passage of time.

In addition, the reliable offloading framework is configured to ensure efficient internal processing by generating separate connectivity threads for respective network interfaces to handle data packet processing and in order to prepare for a potential retransmission of the packets of data due to packet loss. By executing asynchronous operations throughout the overall packet processing pipeline, the reliable offloading framework continues to process packets of data from other network interfaces without delay. Furthermore, packets of data are replicated and transmitted via two or more network interfaces with a zero-copy property constraint, wherein the packets of data are not duplicated to memory during processing. This minimizes the overhead associated with using multiple network interfaces, thus preserving efficiency and maintaining the integrity of the failure-independent network interfaces.

The reliable offloading framework uses asynchronous operations throughout the packet processing pipeline, allowing the proxy to continue processing packets from other interfaces without delay. Additionally, in the reliable offloading framework, packets are processed with a zero-copy property, meaning that the packet data is not duplicated in memory during processing. This minimizes the overhead associated with using multiple interfaces, preserving efficiency and maintaining the integrity of the independence assumption.

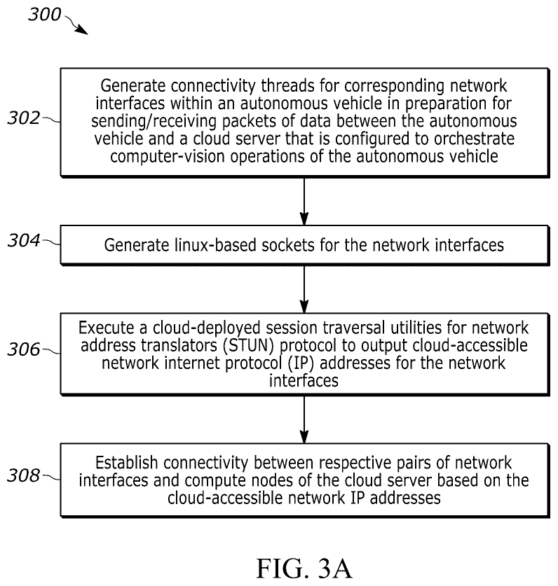

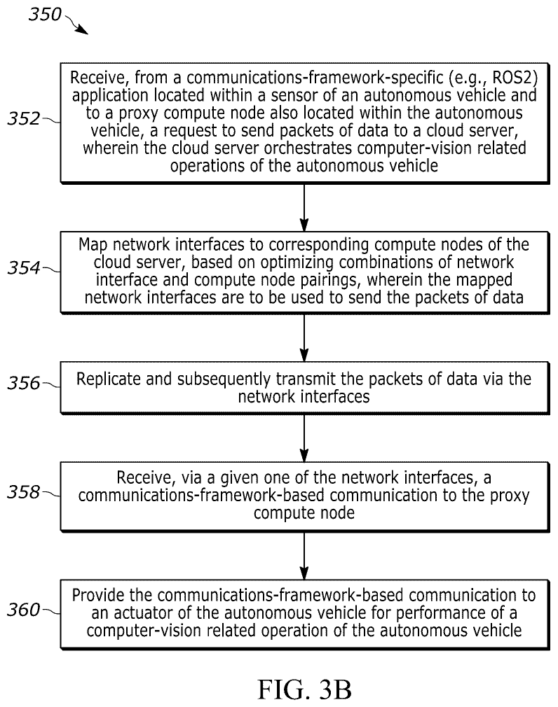

FIG. 3A is a flow diagram that illustrates a process of establishing connectivity between an autonomous vehicle and one or more compute nodes of a cloud server, according to some embodiments.

In some embodiments, process 300 parallels the description provided above for FIG. 2 in which the reliable offloading framework establishes connectivity between at least one proxy compute node and at least one compute node of a cloud server.

In block 302, connectivity threads are generated for corresponding network interfaces within an autonomous vehicle or robot, such as autonomous robot 102 or 202, in preparation for sending and receiving packets of data to and from at least one cloud server that is configured to orchestrate stateless computer-vision related operations of the autonomous robot.

In the process of generating those connectivity threads, Linux-based sockets are generated for the respective network interfaces, and a cloud-deployed STUN protocol is executed to output cloud-accessible network IP addresses for the respective network interfaces, as illustrated in blocks 304 and 306.

Using those cloud-accessible IP addresses, connectivity is thus established between respective pairs of network interfaces and compute nodes of the given cloud server, as shown in block 308. In some embodiments, the establishment of connectivity may include establishment of a bidirectional, peer-to-peer connection, or some similar type of connection.

FIG. 3B is a flow diagram that illustrates a process of communicating, via a proxy compute node, communications-framework-based communications between an autonomous vehicle or robot and one or more compute nodes of a cloud server, according to some embodiments.

In some embodiments, process 350 parallels description provided above for FIG. 2 in which the reliable offloading framework orchestrates ROS2-based communications, or some other communications-framework-based communications, via a proxy compute node between at least one proxy compute node and at least one compute node of a cloud server. Moreover, process 350 illustrates a workflow from a perspective of the autonomous vehicle.

In block 352, a request is received by the reliable offloading framework from a communications-framework-specific application located within a sensor of the autonomous vehicle. The proxy compute node is configured to generate a unique identifier for the request and similarly log the packets of data being requested to send to the cloud server.

In block 354, two or more network interfaces that are located within the autonomous vehicle are mapped to corresponding network interfaces and compute nodes of the cloud server, based on deadline-aware interface-cloud matcher 112.

In block 356, the packets of data are replicated and then transmitted along the selected two or more network interfaces. After an amount of time, a communications-framework-based communication is received by the reliable offloading framework that indicates program instructions for an actuator or controller device of the autonomous vehicle, as indicated in block 358.

In block 360, the communications-framework-based communication is then provided to the corresponding actuator, the communications-framework-specific application, or other controller device in order for the autonomous vehicle to perform a computer-vision related operation.

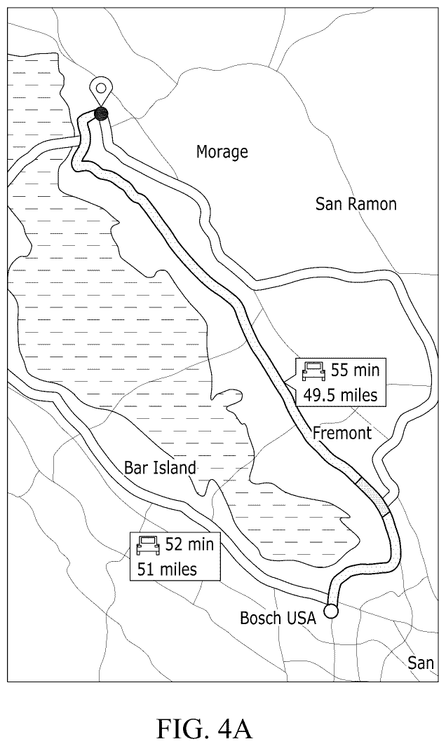

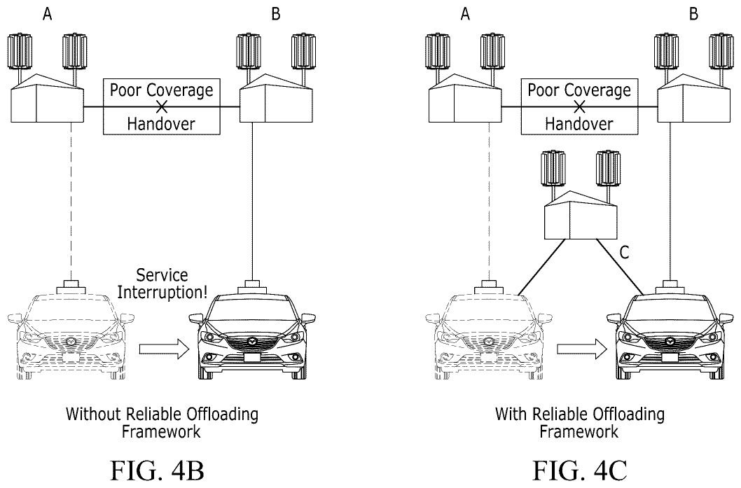

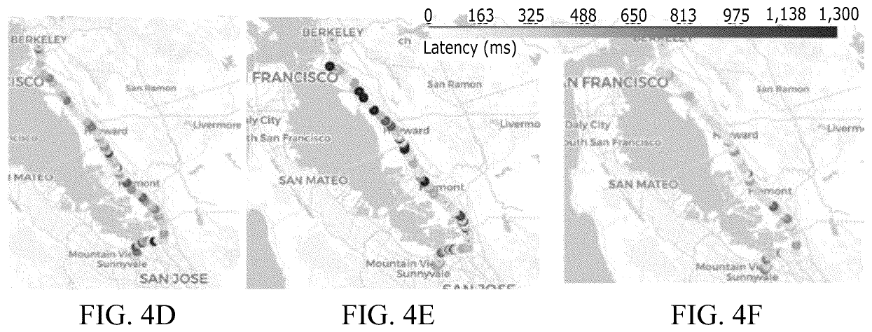

FIGS. 4A-5E now demonstrate the utility and versatility of the reliable offloading framework for cloud robotics applications. The latency-reliability of the reliable offloading framework is proven with a cloud-based operation in a high mobility driving setting with two 5G interfaces in FIGS. 4A-4F. Then, in FIGS. 5A-5E, an indoor human tracking environment with Wi-Fi and 5G is discussed. The reliable offloading framework is quantified by long-tail anomalous latency faults with 99 Percentile (P99) latency, and runs with the top 1% latency.

FIGS. 4A-4C demonstrates maintaining high-quality service in driving scenarios that involve high mobility. More specifically, autonomous vehicles, such as Waymo, Cruise, and Robotaxi, use cloud-based operations to remotely take control in emergencies, such as when a car gets stuck and the onboard algorithms cannot resolve the issue. This cloud operation may involve a tele-operator, a remote data server, or a more sophisticated model.

FIG. 4A a geographical map that illustrates an example driving route taken by an autonomous vehicle within a first case study implementation.

The geographical map illustrates a 50-mile drive along a standard U.S. highway from Sunnyvale, CA to Berkeley, CA, over a 90-minute period during which an autonomous vehicle was driving along the route. The car's speed was maintained by Tesla's Full Self Driving. During the drive, 1280×820 resolution images were streamed as JPEG from an Intel RealSense 435i camera connected to a laptop. The laptop was connected via physical cables to two different 5G hotspots provided by Verizon and AT&T. The decision-making process of a cloud operator was emulated using object detection with YOLOv8. The end-to-end latency was measured from the moment an image was captured to the time a response was received.

FIG. 4B illustrates a moment in time along the driving route shown in FIG. 4A in which a handover causes a service interruption due to lack of use of systems and methods described herein. FIG. 4C illustrates the same moment in time along the driving route shown in FIG. 4A in which the handover does not cause a service interruption, due to the use of systems and methods described herein, according to some embodiments.

FIG. 4D illustrates a number of service interruptions along the driving route shown in FIG. 4A when a single service provider (e.g., Verizon) is used and the systems and methods described herein are not applied to handovers that occur along the driving route. FIG. 4E illustrates another number of service interruptions along the driving route shown in FIG. 4A when another single service provider (e.g., AT&T) is used and the systems and methods described herein are not applied to handovers that occur along the driving route.

FIG. 4F illustrates a decrease in service interruptions along the driving route shown in FIG. 4A due to using the systems and methods described herein during application of handovers that occur along the driving route, according to some embodiments.

This first case study demonstrates that the reliable offloading framework effectively provides smooth quality of service even if one of the two 5G service providers experiences low coverage and base station handover. In the particular experiment shown by FIGS. 4A-4F, the reliable offloading framework improves anomalous long tail P99 (99 Percentile) latency by up to 3.7×.

In comparison, AT&T had higher mean and P99 latency in some extreme cases. The reliable offloading framework effectively leveraged both service providers, offering more reliable latency. The reliable offloading framework improves P99 latency of AT&T and Verizon respectively by 3.7× (4829.35 ms vs 1303.00 ms) and 2.4×(3208.04 vs 1303.00). It improves mean latency (289.44 ms) than AT&T (791.02 ms) and Verizon (550.28 ms).

FIG. 5A illustrates a second case study implementation, shown in FIGS. 5A-5E, of the systems and methods described herein in which two compute nodes of a cloud server orchestrate computer-vision related tasks of an autonomous robot, according to some embodiments.

As shown in FIG. 5A, the reliable offloading framework is deployed on a physical Stretch 3 robot 510, and given an indoor human-tracking task of human 512. Robot 510 is configured with a Wi-Fi network interface 506 and a 5G Dongle 508, which are used to send and receive packets of data to and from cloud servers 502 and 504. Even when robot 510 is within a fully covered Wi-Fi and 5G environment, such as environment 500, the reliable offloading framework improves the responsiveness of the robot by reducing 36% of mean latency and 33% of anomalous long-tail latency.

More specifically, robot 510 is configured to execute Ubuntu 22.04 and ROS2 Humble. The robot 510 was tasked with following human 512 along an indoor route around an office in the given scenario shown in FIG. 5A.

As shown in FIGS. 5B, 5C, 5D, and 5E, the use of the reliable offloading framework improves the P99 long tail latency by 33% (160.00 ms vs 193.52 ms) even in an environment with full coverage of Wi-Fi and 5G network interfaces. The reliable offloading framework consistently improves the average latency by 36% (71.39 ms vs 97.19 ms).

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A computer-implemented method for communicating, via a proxy compute node, communications-framework-based communications, the method comprising:
receiving, from a communications-framework-specific application located within a sensor of an autonomous vehicle and to a proxy compute node located within the autonomous vehicle, a request to send packets of data to a cloud server, wherein the cloud server orchestrates computer-vision related operations of the autonomous vehicle;
mapping two or more network interfaces to corresponding compute nodes of the cloud server, based on optimizing combinations of network interface and compute node pairings, wherein the two or more network interfaces are to be used to send the packets of data;
replicating and subsequently transmitting the packets of data via the two or more network interfaces;
receiving, via a given one of the two or more network interfaces, a communications-framework-based communication to the proxy compute node; and
providing the communications-framework-based communication to an actuator of the autonomous vehicle for performance of a given computer-vision related operation of the autonomous vehicle.

2. The computer-implemented method of claim 1, wherein the mapping the two or more network interfaces to the corresponding compute nodes of the cloud server comprises:
minimizing a probability of missing a latency deadline for respective combinations of network interface and compute node pairings, based on a plurality of network interfaces that are configured to connect to a plurality of compute nodes of the cloud server; and
selecting the two or more network interfaces to be mapped based on optimization of constraints.

3. The computer-implemented method of claim 2, wherein the constraints comprise:
a limit that one of the plurality of network interfaces is connected to one of the plurality of compute nodes at a time; and
a total number of network interface and compute node pairings is less than or equal to a total number of the plurality of compute nodes.

4. The computer-implemented method of claim 1, wherein the packets of data comprise image-based data samples, audio-based data samples, video-based data samples, or text-based data samples, collected from the sensor.

5. The computer-implemented method of claim 1, wherein the request to send the packets of data pertains to a stateless computer-vision related operation of the autonomous vehicle.

6. The computer-implemented method of claim 1, wherein the two or more network interfaces are failure-independent network interfaces, comprising one or more of:
a Wi-Fi interface;
a 5G interface; or
a Cloud Network Interface Card (NIC).

7. The computer-implemented method of claim 1, wherein the replicating and the subsequently transmitting the packets of data via the two or more network interfaces is processed using a zero-copy property constraint.

8. The computer-implemented method of claim 1, further comprising:
receiving, via another one of the two or more network interfaces, the communications-framework-based communication to the proxy compute node;
determining that the communications-framework-based communication received via the other one of the two or more network interfaces is redundant, based on having already received the communications-framework-based communication via the given one of the two or more network interfaces; and
discarding the redundant communications-framework-based communication.

9. The computer-implemented method of claim 1, further comprising:
responsive to the receiving the request to send the packets of data, extracting the request as a serialized request with an identifier;
storing the identifier; and
responsive to the receiving, via the given one of the two or more network interfaces, the communications-framework-based communication to the proxy compute node, verifying that the communications-framework-based communication comprises the identifier that matches the identifier of the request.

10. The computer-implemented method of claim 9, further comprising:
determining, prior to the replicating and the subsequently transmitting, a callback for timeout;
storing the callback for timeout in addition to the identifier; and
responsive to the receiving, via the given one of the two or more network interfaces, the communications-framework-based communication to the proxy compute node, verifying that a passage of time is less than the callback for timeout.

11. The computer-implemented method of claim 1, further comprising:
generating connectivity threads for the two or more network interfaces within the autonomous vehicle;
generating Linux-based sockets for the two or more network interfaces;
executing a cloud-deployed Session Traversal Utilities for Network Address Translators (STUN) protocol to output cloud-accessible network Internet Protocol (IP) addresses for the two or more network interfaces; and
establishing connectivity between the two or more network interfaces and the corresponding compute nodes of the cloud server based on the cloud-accessible network IP addresses.

12. A computer-implemented method for establishing connectivity between a proxy compute node and a cloud server, the method comprising:
generating connectivity threads for corresponding network interfaces within an autonomous vehicle that are configured to send and receive packets of data to a cloud server, wherein the cloud server orchestrates computer-vision operations of the autonomous vehicle;
generating Linux-based sockets for the network interfaces;
executing a cloud-deployed Session Traversal Utilities for Network Address Translators (STUN) protocol to output cloud-accessible network Internet Protocol (IP) addresses for respective ones of the network interfaces;
establishing connectivity between the respective ones of the network interfaces and corresponding compute nodes of the cloud server based on the cloud-accessible network IP addresses; and
sending and receiving, via a proxy compute node located within the autonomous vehicle, communications-framework-based communications for performance of computer-vision related operations of the autonomous vehicle based on the established connectivity.

13. The computer-implemented method of claim 12, further comprising:
responsive to a failure to output a cloud-accessible network IP address for a given one of the network interfaces, disconnect a connectivity thread of the connectivity threads corresponding to the given one of the network interfaces.

14. The computer-implemented method of claim 12, wherein the network interfaces are failure-independent network interfaces comprising one or more of:
a Wi-Fi interface;
a 5G interface; or
a Cloud Network Interface Card (NIC).

15. The computer-implemented method of claim 12, wherein the sending and receiving the communications-framework-based communications comprises:
receiving, from a communications-framework-specific application located within a sensor of the autonomous vehicle and to the proxy compute node, a request to send packets of data to the cloud server;
mapping two or more of the network interfaces to corresponding compute nodes of the cloud server, based on optimizing combinations of network interface and compute node pairings, wherein the two or more network interfaces are to be used to send the packets of data;
replicating and subsequently transmitting the packets of data via the two or more of the network interfaces;
receiving, via a given one of the two or more of the network interfaces, a communications-framework-based communication to the proxy compute node; and
providing the communications-framework-based communication to an actuator of the autonomous vehicle for performance of a given computer-vision related operation of the autonomous vehicle.

16. The computer-implemented method of claim 15, wherein the mapping the two or more of the network interfaces to the corresponding compute nodes of the cloud server comprises:
minimizing a probability of missing a latency deadline for respective combinations of network interface and compute node pairings, based on a plurality of network interfaces that are configured to connect to a plurality of compute nodes of the cloud server; and
selecting the two or more network interfaces to be mapped based on optimization of constraints.

17. A non-transitory, computer-readable medium storing program instructions that, when executed on or across a processor, cause the processor to, comprising:
receive, from a communications-framework-specific application located within a sensor of an autonomous vehicle and to a proxy compute node located within the autonomous vehicle, a request to send packets of data to a cloud server, wherein the cloud server orchestrates computer-vision related operations of the autonomous vehicle;
map two or more network interfaces to corresponding compute nodes of the cloud server, based on optimizing combinations of network interface and compute node pairings, wherein the two or more network interfaces are to be used to send the packets of data;
replicate and subsequently cause the packets of data to be transmitted via the two or more network interfaces;
receive, via a given one of the two or more network interfaces, a communications-framework-based communication to the proxy compute node; and
provide the communications-framework-based communication to an actuator of the autonomous vehicle for performance of a given computer-vision related operation of the autonomous vehicle.

18. The non-transitory, computer-readable medium of claim 17, wherein the program instructions further cause the processor to:
receive, via another one of the two or more network interfaces, the communications-framework-based communication to the proxy compute node;
determine that the communications-framework-based communication received via the other one of the two or more network interfaces is redundant, based on having already received the communications-framework-based communication via the given one of the two or more network interfaces; and
cause the redundant communications-framework-based communication to be discarded.

19. The non-transitory, computer-readable medium of claim 17, wherein the program instructions further cause the processor to:
responsive to the reception of the request to send the packets of data, extract the request as a serialized request with an identifier;
cause the identifier to be stored; and
responsive to the reception, via the given one of the two or more network interfaces, of the communications-framework-based communication to the proxy compute node, verify that the communications-framework-based communication comprises the identifier that matches the identifier of the request.

20. The non-transitory, computer-readable medium of claim 19, wherein the program instructions further cause the processor to:
determine, prior to the replication and the subsequent transmittal, a callback for timeout;
cause the callback for timeout to be stored in addition to the identifier; and
responsive to the reception, via the given one of the two or more network interfaces, of the communications-framework-based communication to the proxy compute node, verify that a passage of time is less than the callback for timeout.
